(19) United States
(12) Patent Application Publication
(10) Pub. No.: US 2026/0316563 A1
(43) Pub. Date: Oct. 15, 2026

(54) VEHICLE PROXIMITY DISPLAY ON USER INTERFACE

(71) Applicant: Indian Motorcycle International, LLC, Medina, MN (US)

(72) Inventors: Benjamin M. Comana, Bem (CH); Tyson Anderson, Linidstrom, MN (US); Brandon Michael Kraemer, Rockford, MN (US); Gabriel James Mezzenga, North Oaks, MN (US); Adam Koosmann, Elk River, MN (US)

(21) Appl. No.: 19/110,538

(22) PCT Filed: Aug. 23, 2023
(86) PCT No.: PCT/US2023/030886

§ 371 Date: Mar. 11, 2025

Related U.S. Application Data
(60) Provisional application No. 63/407,223, filed on Sep. 16, 2022.

(51) Int. Cl. B60K 35/22; B60K 35/10; B60K 35/28; B60K 35/50; B60K 35/65

(52) U.S. Cl. CPC B60K 35/22; B60K 35/10; B60K 35/28; B60K 35/50; B60K 35/654; B60K 2360/119; B60K 2360/166; B60K 2360/167; B60K 2360/168; B60K 2360/169; B60K 2360/178; B60Y 2200/12

(57) ABSTRACT

A method of conveying proximity information to a vehicle operator, including: defining a first proximity zone including a first spatial area in a vicinity of the vehicle and corresponding to a first operator-assistance system; defining a second proximity zone including a second spatial area in a vicinity of the vehicle and corresponding to a second operator-assistance system; displaying a graphical representation of the first proximity zone on a display screen, the graphical representation indicating a first location of the first proximity zone relative to the motorcycle and information of a first operation of the motorcycle; displaying another graphical representation of the second proximity zone on the display screen, thereby indicating a second location of the second proximity zone; determining that an object is in the second proximity zone; and changing a visual characteristic of the second graphical representation, thereby indicating that the object is within the second proximity zone.

### CROSS REFERENCE TO RELATED APPLICATION

This patent application claims the benefit of U.S. Provisional Application No. 63/407,223, filed Sep. 16, 2022, the disclosure of which is incorporated by reference in its entirety.

### FIELD OF THE DISCLOSURE

This disclosure relates to advanced driver assistance systems for vehicles, including motorcycles. More specifically, the disclosure relates to systems, devices and methods for detecting objects, such as vehicles, in proximity regions around a vehicle, and systems, devices and methods for conveying information related to the detected objects to an operator of the vehicle.

### BACKGROUND

The use of advanced driver assistance systems (ADAS) in vehicles, particularly automobiles, is well established and increasingly commonplace. ADAS systems, or more generally, operator-assistance systems, include blind-spot detection (BSD) systems, automatic or emergency brake assist systems, adaptive cruise control (ACC), forward and rearward collision warnings, lane keeping or changing assistance systems, and many more. These systems not only warn drivers of vehicles of their surroundings and impending danger, but may also autonomously respond to potential collisions by braking, steering or decelerating the vehicle.

For example, in known collision-warning or collision-avoidance systems, an ADAS monitors the driving lane in front of and/or behind an automobile to determine whether an object, typically another vehicle, is in the lane ahead or behind. If the other vehicle is within a predetermined vicinity or range, an audible or visual warning to the driver may be issued. Known blind-spot detection (BSD} systems may warn of other vehicles in blind spots through, for example, the use of warning lights in mirrors.

However, known ADAS systems that are tailored to automobile applications do not fully take into account the behaviors and unique needs of motorcycle operators, nor do such disparate systems link features together to provide a convenient and comprehensive visual representation of potential hazards, other vehicles, roadway and vehicle information in and around an entire motorcycle proximity.

### SUMMARY

Embodiments of the present disclosure described herein include methods, systems and devices for presenting to an operator of a vehicle, such as a motorcycle, information relevant to specific determined zones within a motorcycle proximity. Such proximity-zone-specific information may combine information and data from multiple operator-assistance systems and sensors, and may include information relating to positions of moving or stationary vehicles and objects, vehicle operations, potential hazards, roadway signs, and so on.

Embodiments include a user interface, which may include a graphical user interface on a display screen, where other vehicles and hazards are displayed graphically to inform the rider of the vehicle surroundings. The area around the motorcycle, is graphically defined by proximity zones, which are displayed on the graphical proximity user interface or UI for the motorcycle operator. When vehicles or hazards are present in, or are approaching, any of these proximity zones, the proximity UI warns or displays information to the rider. Information may be presented to the vehicle operator in various ways, such as by changing the color or brightness of a zone or showing the hazard graphically in the zone around the vehicle or vehicle operator.

A graphical representation of blind spot detection, rear approach or collision warning, adaptive cruise control, rear and forward latency, and lane change assistance may be displayed. BSD features are expanded to not only show if a vehicle is in a blind spot but to graphically display if a vehicle is approaching a blind spot, and to show if vehicles are tailgating and whether their distance is a hazard. Forward-facing information and zones may be displayed at the set distance setting for the adaptive cruise control (ACC), whether a vehicle is targeted by the radar. Additionally, vehicles in other lanes may be displayed to show if a lane-change assist system is active, or whether the next lane is for on-coming traffic.

In some embodiments, a minimized graphic can be shown, sometimes as an overlay, on all screen images to represent rear blind spot areas, so that the rider can always understand if those zone are clear or contain a hazard.

### BRIEF DESCRIPTION OF THE DRAWINGS

The disclosure can be understood in consideration of the following detailed description of various embodiments in connection with the accompanying drawings, in which:

FIG. 1 is a schematic diagram of a vehicle user-interface device displaying a vehicle-proximity graphical user interface with graphical representations of proximity zones, according to an embodiment of the disclosure;

FIG. 2 is a schematic diagram of proximity zones around a motorcycle, according to an embodiment;

FIG. 3 is schematic diagram of a motorcycle having various operator-assistance systems and a proximity-zone display, according to an embodiment of the disclosure;

FIG. 4 is a block diagram of a sensing and control system for a motorcycle, according to an embodiment of the disclosure;

FIG. 5 is a flow chart depicting a method of conveying proximity information to an operator of a vehicle;

FIG. 6 is a schematic diagram of a proximity UI indicating information via a first color, and displayed over a vehicle system graphical user interface (GUI) displaying motorcycle operational and status information, according to an embodiment of the disclosure;

FIG. 7 is a schematic diagram of a proximity UI indicating information via a second color, and displayed over a vehicle system GUI displaying motorcycle operational and status information, according to an embodiment of the disclosure;

FIG. 8 is a schematic diagram of a proximity UI indicating information via a third color, and displayed over a vehicle system GUI displaying motorcycle operational and status information, according to an embodiment of the disclosure;

FIG. 9 is a schematic diagram of a proximity UI indicating information via a first color, and displayed over a vehicle system graphical user interface (GUI) displaying navigation information, according to an embodiment of the disclosure;

FIG. 10 is a schematic diagram of a proximity UI indicating information via a second color, and displayed over a vehicle system GUI displaying navigation information, according to an embodiment of the disclosure;

FIG. 11 is a schematic diagram of a proximity UI indicating information via a third color, and displayed over a vehicle system GUI displaying navigation information, according to an embodiment of the disclosure;

FIG. 12 is a schematic diagram of a proximity UI indicating information relating to a blind spot area, and displayed over a vehicle system GUI displaying motorcycle operational and status information, according to an embodiment of the disclosure;

FIG. 13 is a schematic diagram of a proximity UI indicating information relating to another blind spot area, and displayed over a vehicle system GUI displaying motorcycle operational and status information, according to an embodiment of the disclosure;

FIG. 14 is a schematic diagram of a proximity UI indicating information relating to yet another blind spot area, and displayed over a vehicle system GUI displaying motorcycle operational and status information, according to an embodiment of the disclosure;

FIG. 15 is a schematic diagram of a proximity UI indicating information relating to a blind spot area, and displayed over a vehicle system GUI displaying navigation information, according to an embodiment of the disclosure; and

FIG. 16 is a schematic diagram of a proximity UI indicating information relating to another blind spot area and displayed over a vehicle system GUI displaying navigation information, according to an embodiment of the disclosure.

### DETAILED DESCRIPTION

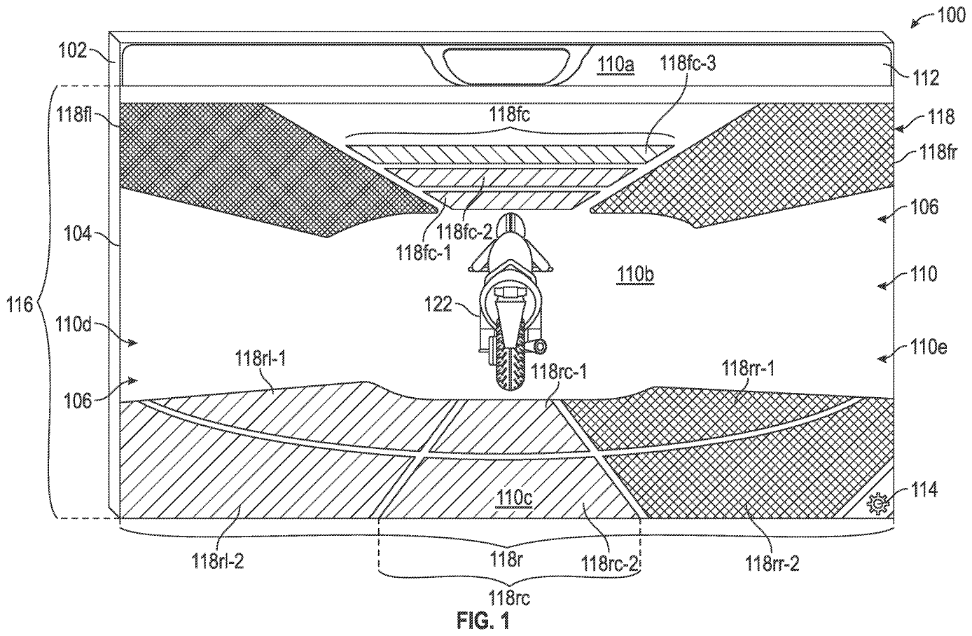

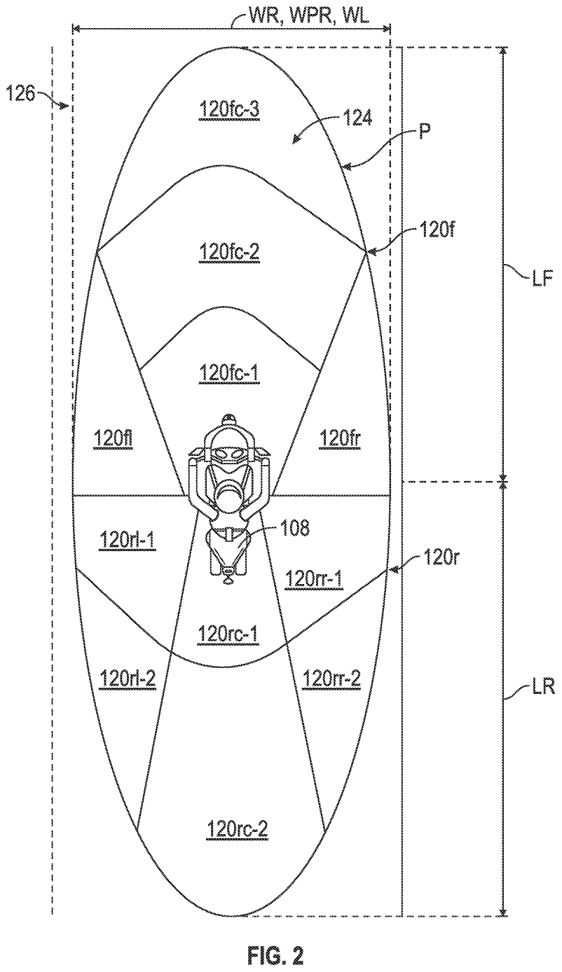

Referring to FIG. 1 an embodiment of vehicle user-interface device 100 for a vehicle, such as a motorcycle, that includes vehicle display device 102 having electronic display-screen device (“display screen”) 104 for displaying vehicle-proximity graphical user interface (“proximity UI”) 106, is depicted. Display screen 104 may comprise a computer screen, touch screen and so on, utilizing liquid crystal display (LCD), light-emitting diode (LED), organic light-emitting diode (OLED), or other known display-screen technologies. As will be explained in further detail below, proximity UI 106 may present or display images, graphics, text or other information relating to objects, such as other vehicles, in proximity to the vehicle, such as motorcycle 108 depicted in FIG. 2.

Although embodiments of vehicle user-interface device 100 include proximity UI 106, vehicle user-interface device 100 may comprise a comprehensive vehicle user-interface device, providing a display device and user-interface for displaying, communicating and controlling information, settings and operations of multiple vehicle systems. For example, vehicle user-interface device 100, in addition to proximity UI 106, may also include other user interfaces relating to vehicle operation, operator-assistance system (OAS) settings, navigation, vehicle diagnostics, communications, audio, weather, traffic, and more.

Display screen 104 is positioned to be viewable to an operator of motorcycle 108 while seated on, and operating the motorcycle, so that information can be visually communicated to the operator via the display screen 104.

An operator of motorcycle 108 may interact with vehicle-proximity user-interface device 100 and proximity UI 106 to change various settings and functions of device 100 and proximity UI 196. In an embodiment, display screen 104 comprises a touch screen that is responsive to an operator touching a surface of the display screen 104. In such an embodiment, proximity UI 106 may display graphical icons or menus indicating particular areas of display screen 104 to be touched so as to select displayed information. In some embodiments, vehicle user-interface device 100 and/or proximity UI 106 may include other software-or hardware-implemented interface tools such as scroll wheels, buttons, joysticks, voice-commands, and so on.

In an embodiment, proximity UI 106 includes at least one window 110 comprising a defined area of display screen 104 for displaying graphical depictions and representations to the motorcycle 108 operator. Window 110 may be divided into smaller window areas or regions for displaying static or dynamically changing information. In one such embodiment, window 110 includes a defined upper window area 110a such as for a title bar 112, as depicted, which in an embodiment may stay relatively static or constant, a central area 110b which may be used to display the primary graphical information, and lower area 110cc, which may be used, for example, to display various icons, such as settings icon 114. Central area 110b may also include left area 110d and right area 110e, used to display additional information, as described below.

In an embodiment, a first or primary configuration of proximity UI 106 depicts and includes motorcycle-proximity map 116, in window area 110b, having a plurality of graphical motorcycle proximity-zone representations “graphical proximity zones”) 118. As described further below with respect to FIG. 2, motorcycle-proximity map 116 and its proximity zone representations 118 represent associated actual spatial motorcycle proximity zones, areas or regions (“proximity zones”) 120 around a vehicle, such as a motorcycle. Proximity UI 106, in an embodiment, also depicts vehicle icon 122 representing motorcycle 108 and its operator, and as described briefly above, may include other graphical information or icons, such as title bar 112 and settings icon 114.

Referring to both FIGS. 1 and 2, motorcycle-proximity map 116 with its graphical proximity zones 118 represent motorcycle-proximity region 124 and its proximity zone 120. Motorcycle-proximity region 124 is a defined spatial area within a proximity of, or in the vicinity of, motorcycle 108 and its operator at a given instant of time, as described further below. Motorcycle-proximity region 124 is divided into multiple proximity zones 120.

Referring specifically to FIG. 2, which is a schematic diagram not intended to be drawn to scale, motorcycle-proximity region 124 comprising a plurality of proximity zones 120 may include an area of a roadway or lane 126 in which motorcycle 108 is traveling, an adjacent lane, an oncoming lane, and even areas adjacent to the roadway, including road shoulders, ditches and nearby areas. Motorcycle-proximity region 124 and its proximity zones 120 may be static in size and shape, or may dynamically change based on operator input and/or preferences, motorcycle operation, roadway size and conditions, detected hazards and detected vehicles, and other such factors. For example, a depicted forward distance and area may be increased with motorcycle speed, or a depicted rearward distance and area may be increased if a vehicle approaches motorcycle 108 from the rear. As such, in embodiments, motorcycle-proximity region 124 and any of its proximity zones 120 may be dynamically defined during motorcycle 102 operation.

Proximity zones 120 may be determined and defined by one or more processors of motorcycle 108. A proximity zone 120 may be defined based on data from sensors and operator-assistance systems of motorcycle 108, as described further below.

Systems, devices and methods for determining and defining proximity zones or regions are described in International application No. PCT/US2022/049880, published as WO2023/132892, entitled “Dynamically-Adaptable Proximity Regions for a Motorcycle,” which is incorporated herein in its entirety.

In an embodiment, the plurality of proximity zones 120 together comprise motorcycle-proximity region 124, and includes one or more forward proximity zones 120f, and one or more rear proximity zones 120r. In an embodiment, and as depicted, forward proximity zones 120f extend from motorcycle 108, and in an embodiment, from a center of motorcycle 108, in a direction of travel (forward direction) of motorcycle 108. In an embodiment, and as depicted, rear proximity zones 120r extend from motorcycle 108, and in an embodiment, from a center of motorcycle 108, in a direction opposite to the direction of travel (rearward direction) of motorcycle 108. Both forward and rear proximity zones 120f and 120r extend laterally, in a direction perpendicular to the direction of travel.

In an embodiment, motorcycle-proximity region 124 includes forward proximity zone 120f having three distinct forward proximity zones, namely, forward-right proximity zone 120fr, forward-center proximity zone 120fc, and forward-left proximity zone 120fl. Also as depicted, motorcycle-proximity region 124 includes rear proximity zone 120r, having three distinct rear proximity zones 120, namely, rear-right proximity zone 120rr, rear-center proximity zone 120rc, and rear-left proximity zone 120rl.

Any of the proximity zones 120 may be sub-divided into smaller sub-zones. In the depicted embodiment, forward-center proximity zone 120fc, which is particularly relevant because it includes areas directly in front of, or forward of, the motorcycle and operator, includes three forward-center proximity zones 120fc, namely, first forward-center proximity zone 120fc-1, second forward-center proximity zone 120fc-2 and third forward-center proximity zone 120fc-3. As depicted, first forward-center proximity zone 120fc-1 is closest to motorcycle 108, second forward-center proximity zone 120fc-2 and third forward-center proximity zone 120fc-3. Although three forward-center proximity sub-zones are depicted and described with respect to this embodiment, it will be understood that the number of sub-zones per proximity zone may vary, and may comprise more or fewer than three. A larger number of sub-zones generally convey more detailed or granular information to the motorcycle operator.

In the embodiment depicted, each rear proximity zone 120r includes two sub-zones, such that rear-right proximity zone 120rr includes first rear-right proximity zone 120rr-1 and second rear-right proximity zone 120rr-2; rear-center proximity zone 120rc includes first rear-right proximity zone 120rc-1 and second rear-center proximity zone 120rc-2; and rear-left proximity zone 120rl includes first rear-left proximity zone 120rl-1 and second rear-left proximity zone 120rl-2. Rear proximity zones 120r may comprise more or fewer rear proximity zones 120r than are depicted in FIG. 2.

In the embodiment depicted, motorcycle-proximity region 124 is defined by perimeter P, and is generally defined as a symmetrical oval shape, with forward proximity region 120f having a same general size and shape of rear proximity region 120r, with region 120r being a mirror image of region 110f.

In this embodiment, motorcycle-proximity area 124 defines length LPR and width WPR; forward proximity zone 120f defines length Lf and width Wf; and rear proximity zone 120r defines length Lr and width Wr.

In an embodiment, length LPR and width WPR may be fixed in dimension, such that length and width are maintained as motorcycle 108 moves in an intended direction. In other embodiments, based upon detected objects, length LPR and width WPR, as well as an overall shape of motorcycle-proximity region 124, may be dynamically adjusted.

Referring also to FIG. 1, in an embodiment, each displayed graphical proximity zone 118 corresponds to an actual proximity zone 120 as determined by system 152. In an embodiment, and not limited to the following, in determining an actual proximity zone 120, system 152 may define particular boundaries by defining a length, width, etc., may estimate proximity zones 120 based on known sensor characteristics, may determine a proximity zone based on a range of one or more sensors, may determine a proximity zone without defining a particular size, but by simply allocating data from one or more sensors into a particular proximity zone database or memory.

In the depicted embodiment, forward graphical proximity zones 118f having forward-right, center and left zones 118fr, 118fc (with zones 118fc-1, 118fc-2 and 118fc-3) and 118fl, respectively, correspond to actual forward proximity zones 120 f having forward-right, center and left zones 120fr, 120fc (with zones 120fc-1, 120fc-2 and 120fc-3) and 120fl, respectively; rear graphical proximity zones 118r with rear-right, center and left zones 118rr (with zones 118rr-1 and 118rr-2), 118rc (with 118rc-1 and 118rc-2) and 118rl (with 118rl-1 and 118rl-2), respectively, correspond to actual rear proximity zones 120r with rear-right, center and left zones 120rr (with zones 120rr-1 and 120rr-2), 120rc (with 120rc-1 and 120rc-2) and 120rl (with 120rl-1 and 120rl-2), respectively.

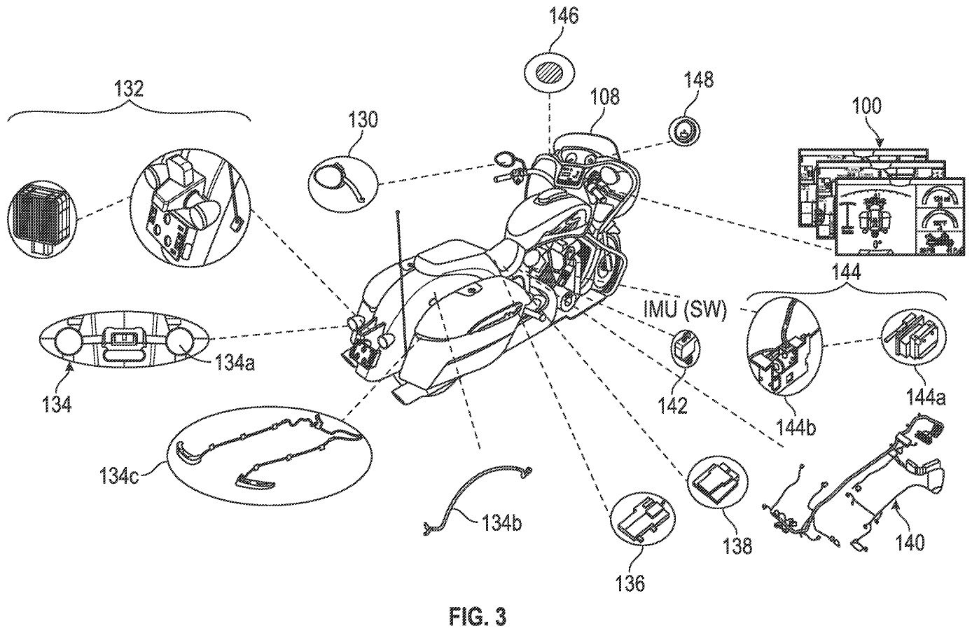

Referring to FIG. 3, an embodiment of motorcycle 108 with exemplary hardware and software devices and systems related to sensing and processing environmental data and controlling operation of motorcycle 108, including multiple operator-assistance systems or ADASs is depicted. Although the term “motorcycle” is used herein, it will be understood that “motorcycle” refers to, and encompasses, any motorized vehicle having a seat or saddle for the use of the operator/rider, and that is designed to travel on not more than three wheels in contact with the ground. In an embodiment, motorcycle 108 includes vehicle proximity user-interface device 100, BSD mirror assembly 130 with indicator lights and wiring harness, rear sensors 132 (e.g., including radar, which may be a mid-range or other radar, such as radar or lidar, and which may be a rear-, or forward-mounted radar), rear lighting system 134 with tail-light/turn signal lighting 134a, taillight wiring harness 134b and optional saddlebag lighting and wiring assembly 134c, engine control module (ECM) 136, vehicle control module (VCM) 138, chassis wiring harness 140, inertial momentum unit (IMU) 142, brake system 144 with brake module 144a and brake lines and brackets 144b, forward sensors 146 (e.g., radar, lidar, camera), and instrument cluster or CPI 148 (including, e.g., speedometer, tachometer, TPMS lamp, ABS lamp, high/low beam indicators, and so on). It will be understood that motorcycle 108 may also include additional devices and systems in addition to, or rather than, those depicted and described herein.

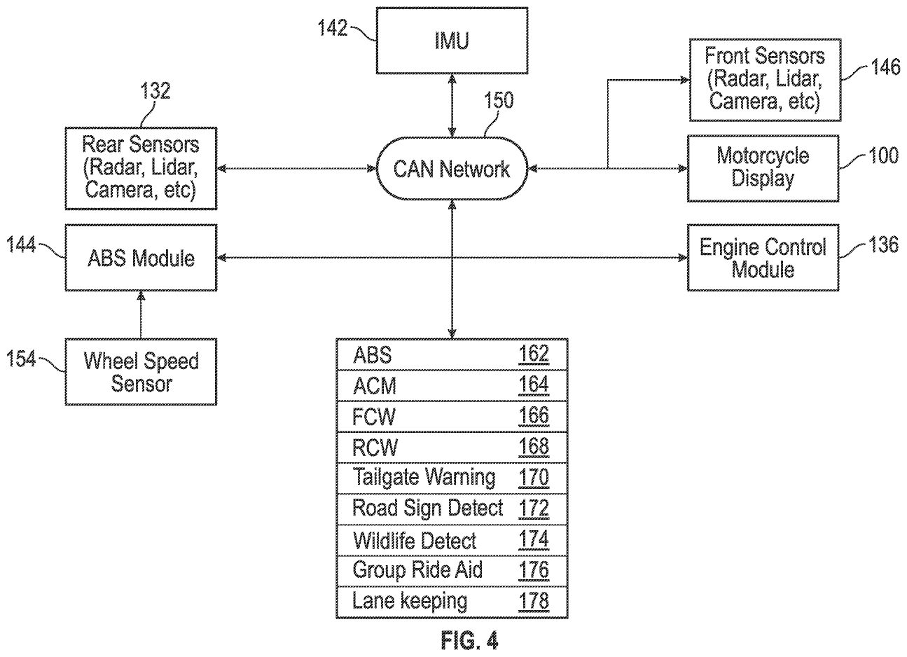

Referring also to FIG. 4, the various devices and systems depicted and described above with respect to FIG. 3 are generally in communication with system control components via a controller area network bus 150 (CAN bus) as part of motorcycle control system 152, as depicted in FIG. 3, and may form various advanced driver assistance systems (“ADASs”) or operator-assistance systems (“OASs”). For the sake of description herein, a system that aids or assists an operator of a vehicle, including a motorcycle, will be referred to generally as an “operator-assistance system” (OAS), and it will be understood that such systems also include systems described in the art as ADASs.

OASs of motorcycle 108 may include blind-spot detection (BSD) system 160, automatic or emergency/anti-lock braking system (ABS) 162, adaptive cruise control (ACC) 164, forward collision warning (FCW) system 166, rearward collision warning (RCW) system 168, tailgate warning systems (RLADI) 170, road-sign detection system 172, wildlife detection system 174, group-ride-aid system 176, and lane keeping or changing assistance systems 178. Although these OASs are depicted as discrete elements of the block diagram of FIG. 4, it will be understood that while these OASs may be discrete systems, they may also be collections of functions performed by other systems and processors of sensing and control system 152. For example, front sensors 146 may provide sensed data to ECM 136 which processes the sensed data and warns of a potential front collision, such that this combination of devices and systems comprises a forward collision warning system 166.

Sensing and control system 152, in an embodiment, comprises vehicle proximity user-interface device 100, rear sensors 132, ECM 136, IMU 142, brake module 144 (which in an embodiment is an automated braking system-ABS module), front sensors 146, CAN bus 150, and wheel-speed sensor 154, and the OASs 160-178.

Rear sensors 132 may be mounted at or near a rear portion of motorcycle 108, and may comprise sensors for detecting objects, such as other vehicles, in the vicinity or proximity of motorcycle 108, as well as determining the speed and/or position of those other vehicles. In an embodiment, rear sensors 132 may be positioned to sense vehicles rearward, and to a certain extent, leftward and rightward of motorcycle 108. In embodiments, rear sensors 132 may include one or more of a radar system, a lidar system, cameras and camera systems, or other such detecting systems.

Rear sensors 132 may comprise a component of one or more OASs, any of which may be a subsystem or feature of system 152. Rear sensors 132 may in particular comprise a component of a blind spot-detection (BSD) system 160, and therefore be positioned and configured to detect objects and vehicles in blind spots (areas not shown in mirrors) of the motorcycle 108 operator, in addition to objects and vehicles further behind, and perhaps approaching, motorcycle 108. Rear sensors 132 may also comprise a component of an RCW 168, tailgate warning system 170, group-ride-aid system 176, or lane keeping or changing assistance system 178.

Similarly, front sensors 148 may be mounted at or near a front portion of motorcycle 108, and may comprise sensors for detecting objects, such as other vehicles in the vicinity or proximity of motorcycle 108, as well as determining the speed and/or position of those other vehicles. In an embodiment, front sensors 148 may be positioned to sense vehicles forward/in front of, and to a certain extent, leftward and rightward of motorcycle 108. Front sensors 148 may include one or more of a radar system, a lidar system, a camera system, or other such detecting system.

Front sensors 148 may also comprise a component of one or more OASs any of which may be a subsystem or feature of system 152. Front sensors 146 may in particular be part of a blind-spot detection (BSD) system, automatic or emergency brake assist system (ABS), adaptive cruise control (ACC), forward collision warning (FCW) system, road-sign detection system, wildlife detection system, group-ride-aid system, lane keeping or changing assistance system, and more. Rear sensors 132 and front sensors 146 are communicatively coupled to engine control module (ECM) 126 through CAN bus 150, providing sensor data to ECM 126. Although sensors 132 and 146 are described herein as “rear” and “front” sensors, respectively, it will be understood that a sensing area of sensors 132 and 146 is not strictly limited to areas that are rearward or forward of motorcycle 108, and may also include areas laterally adjacent to motorcycle 108.

Rear sensors 132 and front sensors 146 generally may provide or contribute to objection detection, location, velocity, acceleration and direction of travel.

IMU 142 is configured to measure and indicate various motorcycle orientations, velocity and gravitational forces. Embodiments may provide data and calculations of motorcycle roll (lean), pitch and yaw angles, velocities and accelerations. In an embodiment, IMU 142 includes an IMU processor, and one or more of an accelerometer and gyroscope.

ABS module 144, in addition to facilitating anti-lock braking of motorcycle 108, ABS module 144, in an embodiment, may be configured to calculate, or contribute to calculation of, motorcycle 108 speed, to allow radar to make necessary corrections to calculations.

CAN bus 150 comprises a network of wiring, connectors, and so on to as to transfer data and facilitate communication between the various connected modules and components of sensing and control network 152.

Wheel speed sensor 154 may be mounted at or near a front and/or rear wheel of motorcycle 108, and in an embodiment is communicatively linked to ABS module 144 and ECM 136. Wheel speed sensor 154 provides data relating to motorcycle 108 wheel speed, which normally indicates motorcycle 108 speed.

ECM 136, which in the art may also be known as an “engine control unit” or ECU, is in electrical communication with the sensors, systems and components of system 152 via CAN bus 150. In an embodiment, ECM 136 may include one or more processors or microcontrollers, memory devices, and other hardware and software components. ECM 136 is configured to control the various systems and operations of motorcycle 108 based on data provided by sensors and systems described above, including those of system 152.

ECM 136 is also in electrical communication with vehicle-proximity user-interface device 100. As described further below, ECM 136, in an embodiment, is configured to receive the various data inputs from the sensors and systems of sensing and control system 152, e.g., IMU 142, rear and front sensors 132, 146, and so on, and motorcycle 108 operator, then based on this data, define motorcycle-proximity region 124 with proximity zones 120, as well as graphical motorcycle-proximity map 108 with graphical proximity zones 118. In an embodiment, ECM 136 also controls the display of map 116 with graphical proximity zones 118, including the display of relevant hazards, approaching vehicles, roadway information, vehicle operations and so on. As part of this control, and as described further below, ECM 136 may also determine and configure display parameters of map 116 and graphical proximity zones 118, such as displayed size, shape and colors, and warning information. Warning and other information, displayed in various graphical and/or textual forms, may relate to blind spot detection, tailgate warning, rear collision warning, forward collision warning, road sign detection for speed limits and traffic control, wildlife detection and warning, group ride aid information, and more.

Referring also to FIG. 2, in an embodiment, ECM 136 receives and processes data from the various OASs and devices of system 152, including one or more of rear sensors 132, front sensors 146, IMU 142, and ABS module 144a, to determine and define the characteristics of motorcycle-proximity region 124 and its proximity zones 120, including size and shape.

Examples of known OASs or ADAS are described in the following patents and patent publications, all of which are incorporated by reference herein in their entireties, and may be used to implement systems and methods relating to vehicle user-interface device 100 as described herein: WO 2020/041191 A1, published Feb. 27, 2020, entitled “Wheeled Vehicle Notification System and Method,” and owned by Indian Motorcycle International, LLC; US 2021/0188270, published Jun. 24, 2021, entitled “Wheeled Vehicle Adaptive Speed Control Method and System,” and owned by Indian Motorcycle International, LLC; US 2021/0162998 A1, published Jun. 3, 2021, entitled “Control Device and Control Method for Controlling Behavior of Motorcycle,” and having an applicant Robert Bosch GmbH; US 2020/0231170 A1, published Jul. 23, 2020, entitled “Method and Control Device for Monitoring the Blind Spot of a Two-Wheeled Vehicle,” and having an applicant Robert Bosch GmbH; and U.S. Pat No. 10,429,501, issued Oct. 1, 2019, entitled “Motorcycle Blind Spot Detection System and Rear Collision Alert Using Mechanically Aligned Radar,” and having an applicant Continental Automotive Systems, Inc.; EP 3640918A1, published on Apr. 22, 2020, entitled “Processing Unit and Processing Method for Front Recognition System, Front Recognition System, and Motorcycle,” and having an applicant Robert Bosch GmbH; EP 3800099A1, published May 31, 2019, entitled “Leaning Vehicle,” and having an applicant Yamaha Hatsudoki Kabushiki Kaisha Iwata-shi; US 2020/0108830A1, published Apr. 9, 2020, entitled “Method for Automatically Adjusting the Speed of a Motorcycle,” and owned by having an applicant Robert Bosch GmbH; and U.S. Pat No. 9,802,537, issued Oct. 31, 2017, entitled “Approach Notification Device of Straddle Type Vehicle,” and having an applicant Honda Motor Co., Ltd.

In an embodiment, length L_{PR} and width W_{PR} may be fixed in dimension, such that length and width are maintained as motorcycle 108 moves in an intended direction of travel. In other embodiments, ECM 136 based on data received, may dynamically adjust length L_{PR} and width W_{PR}, as well as an overall shape of motorcycle-proximity region 124. For example, at relatively high speeds, as sensed by wheel speed sensor 154 and communicated by ABS module 144, ECM 136 may increase length L_{PR} so as to provide an operator of motorcycle 102 with sufficient time to perceive and potentially react to information presented by proximity UI 106 at display device 104. In another embodiment, length Lf of forward proximity zone 120f is increased due to an increase in speed since objects in front of motorcycle 108 will be encountered more quickly as compared to at a lower speed. At the same time, length Lr of rear proximity zone 120r may be decreased since vehicles approaching from the rear of motorcycle 108 may approach at a relatively slower speed when motorcycle 108 is traveling at a relatively high speed. In yet another example embodiment, width W_{PR} may be dynamically increased or decreased as lane 126 increases and decreases; or may be decreased to as part of a group ride aid so as to allow fellow riders to be within a zone without being perceived as a hazard; or may be increased to include an opposing-traffic lane.

Similarly, lengths and widths of individual proximity zones 120 may vary in size and shape, and may define sizes and shapes that are fixed or constant or that may also be dynamically varied.

As depicted, length L_{PR} may be greater than W_{PR}. As also depicted, width W_{PR}may be substantially the same as, or similar in width to roadway lane 126 in which motorcycle 108 is positioned. In an embodiment, motorcycle-proximity area 124 is similar in width as compared to roadway lane 126, such that width W_{PR} may be substantially the same as a width of roadway lane 126. Such a defined width may be beneficial in that all potential hazards, objects and vehicles within lane 126 may be located within motorcycle-proximity region 124, and therefore become the potential subject of an informational alert or warning. In other embodiments where motorcycle-proximity area 124 is smaller in width as compared to a roadway lane 126, width W_{PR} may be fixed in size, or may dynamically change, within a range of range of 50% to 100% of a width of roadway lane 126; in another embodiment width W_{PR}is in a range of 75% to 100% of a width of roadway lane 126.

In an embodiment, dynamic changes in a size and shape of motorcycle-proximity area 124 and/or proximity zones 120 may be indicated and dynamically displayed as motorcycle proximity map 116 with graphical proximity zones 118 on vehicle-proximity user-interface device 100. However, in other embodiments, proximity UI 106 may maintain the displayed relative size and/or shape of graphical proximity zones 118 even though ECM 136 is dynamically changing the relative size and/or shape of an actual motorcycle-proximity area 124 and/or proximity zones 120. Such an embodiment allows for appropriate sensing and inclusion of potential hazards and vehicles within motorcycle-proximity area 124 and proximity zones 120 without changing the displayed appearance of the area and zones to the operator, potentially simplifying the display and interpretation of information presented to the motorcycle 108 operator.

As described above, in an embodiment, one purpose of defining proximity zones 120 and displaying corresponding graphical proximity zones 118 is to inform an operator of motorcycle 108 of objects in, near or approaching proximity zones 120. Such objects may include moving objects, such as moving vehicles, pedestrians, wildlife, or even moving inanimate objects. In an embodiment, detected objects may be stationary objects that present a potential hazard to motorcycle 108 and its operator, such as road debris. In other embodiments, detected objects may be stationary objects that do not present a potential hazard to motorcycle 108 and its operator, such as road signs, lane markers, and so on.

Referring to FIGS. 1 and 2, individual or groups of proximity zones 120 and corresponding graphical proximity zones 120 may be associated with one or more OASs and/or sensors. Data detected from sensors and systems of sensing and control system 152, and related OASs may be received and processed by a controller or processor, such ECM 136, to determine whether an object is in, near or approaching a particular predetermined proximity zone 120. ECM 136 or a related imaging system of, or in communication with, device 100 causes a display characteristic of the corresponding graphical proximity zone 118 to be changed or updated to visually indicate to an operator of the motorcycle 108 that a potential hazard exists, or to indicate other information. Such display characteristics or visual indications related to warnings may include one or more of changing a color of all or part of the zone, e.g., from green, yellow or orange to red, causing the graphical proximity zone 118 to flash on and off, changing a brightness, changing a graphical zone size, e.g., enlarging the zone, displaying an addition graphical icon on or near the relevant zone, such as a vehicle icon, pedestrian icon, object icon, adding a textual message, e.g., “warning,” “slow down,” etc., and other such indications, either alone or in combination. Such visual indications displayed as part of proximity UI 106, in an embodiment, may also be accompanied by auditory indications, such as electronic or verbal warning messages played over speakers or a communications system.

Information detected from sensors and OASs of system 152 may also be used to convey information via proximity UI 106 that is not necessarily related to a potential hazard, such as road speed limits, upcoming traffic control signs, motorcycle 108 current speed, and so on, by detecting road signs using front and/or rear cameras. Such non-hazard information may be presented in a predetermined, particular graphical proximity zone 118, or may be presented elsewhere in window 110, such as in a central window area 110b, to the left or right of motorcycle icon 122, so as to avoid interference with display of graphical proximity zones 118.

In an embodiment, forward-central proximity zones 120fc-1, 120fc-2 and 120fc-3 and corresponding graphical proximity zones 118fc-1, 118fc-2 and 118fc-3 may be associated with forward-collision-warning (FCW) system 166 and adaptive cruise control (ACC) system 164. In one such embodiment, the closest forward-central proximity zone, zone 120fc-1, may be associated with FCW system 166, informing or warning an operator of motorcycle 108 of a potential forward collision by changing a display characteristic of first forward-central graphical proximity zone 118fc-1. Proximity zone 120fc-1 and corresponding graphical proximity zone 118fc-1 may be associated with only FCW system 166, warning of potential collisions, but may also be associated with an additional OAS, such as ACC system 164. ACC system 164 may also be associated with forward-center proximity zones 120fc-2 and 120fc-3, and their graphical proximity zones 118fc-2 and 118fc-3.

ACC system 164, associated with a plurality of proximity zones, causes a cruising speed of motorcycle 108 to be automatically adjusted due to the presence of other vehicles forward of motorcycle 108. When ACC system 164 is associated with multiple proximity zones 120 and graphical proximity zones 118, graphical proximity zones 118 may be used to visually indicate the presence of a vehicle ahead. In one such embodiment, as motorcycle 108 travels forward and closer to the other vehicle, causing the other vehicle to be detected in a further proximity zone, such as proximity zone 120fc-3, followed by zone 120fc-2, then zone 120fc-3, graphical proximity zones 118fc3, 118fc-2 and 118fc-1 may sequentially each indicate the presence of the other vehicle, while ACC system 164 simultaneously decreases a speed of motorcycle 108.

Forward-left graphical proximity zone 118fl and forward-right graphical proximity zone 118fr may each be used to warn an operator of moving or stationary objects in, near or approaching such zones by changing a displayed characteristic of the respective graphical proximity zone. In an embodiment, all or a portion of forward-left graphical proximity zone 118fl and forward-right graphical may be associated with blind-spot detection (BSD) system 160.

Rear-left graphical proximity zone 118rl and rear-left graphical proximity zone 118rr may be associated with BSD 160, warning an operator of moving or stationary objects in, near or approaching such zones by changing a displayed characteristic of the respective graphical proximity zone. Detection data from BSD 160 may be used to alert the operator of a vehicle in an area not viewable in the mirrors of motorcycle 108, i.e., a vehicle in the operator's “blind spot.” That same data may be used to operate traditional blind-spot warning/indicator lights in BSD mirror assemblies 130 (see also, FIG. 3), but may also be used to cause proximity UI 106 to provide a visual warning via the appropriate graphical proximity zone, such as zone 118rl or 118rr.

Rear-left graphical proximity zone 118rl and rear-left graphical proximity zone 118rr may also be associated with group-ride-aid system 176 of the present disclosure, and may display information relevant to riding motorcycle 108 in a group. Group-ride-aid system 176, in an embodiment, uses one or more front and rear sensors 132, 146, such as radar, lidar and cameras, to detect the location of other, adjacent motorcycles. Detected data is processed by system 152 to determine where the other motorcycles are with respect to proximity zones 120, including which proximity zones 120 the other motorcycles may be located. The presence of other motorcycles in, near or adjacent to a proximity zone 120 is indicated using proximity UI 106. In an embodiment, a graphical proximity zone 118 displays a visual indication of the presence of other proximate motorcycles within that zone 118 in a manner similar to that described above with respect to indicating that a vehicle is in, near or approaching a proximity zone 120. In the case of a group ride with multiple other motorcycles, multiple graphical proximity zones 118 may simultaneous indicate the presence of multiple other proximate motorcycles in multiple proximity zones 120.

While such a feature may be particularly useful for indicating proximate motorcycles in blind spot proximity zones 120, such as rear-left and rear-right proximity zones 120, any of the available proximity zones 120 and corresponding graphical proximity zones 118 may be used to track or indicate the presence of proximate motorcycles of a group.

In an embodiment, a color of a graphical proximity zone 118 may change, or the zone may flash, or grow and shrink in size, in response to another motorcycle entering a proximity zone associated with the indicating graphical proximity zone 118.

In another embodiment, additional graphical icons representing other motorcycles, such as, for example, motorcycle icon 122, may be displayed. Display of proximate motorcycle graphical icons may be in addition to the visual indication provided by one or more graphical proximity zones 118.

Rear-center proximity zones 120rc, including first and second rear-center proximity zones 120rc-1 and 120rc-2, in an embodiment, are associated with rear-collision warning (RCW) system 168 and/or tailgate warning system 170. RCW system 168 is configured to detect vehicles approaching motorcycle 108 from a rearward to forward direction by processing data from sensors, including received from rear sensors 132, and determines whether the approaching vehicle is on a trajectory to collide with motorcycle 108. Tailgate warning system 170 also receives information from rear sensors 132 and determines whether a vehicle rearward of motorcycle 108 is particularly close, i.e., is “tailgating,” and is thusly following too closely, at an unsafe distance. Upon determining a potential rear collision or a vehicle following unsafely close, system 152 communicates with device 100 causing proximity UI 106 to activate a change to displayed rear-center proximity zones 120rc, or to otherwise use rear-center proximity zones 120rc to provide a warning to the operator of the motorcycle 108.

Proximity user-interface device 100 may be configured to receive input from an operator of motorcycle 108 as described briefly above. In an embodiment, device 100 is configured to receive input from the operator so as to modify operator settings and preferences regarding graphical proximity zones 118. In an embodiment, a desired following distance for ACC may be received and used to determine a length of front-center proximity zones 120fc, which affects when corresponding front-center graphical proximity zones 120fc are activated, or indicates. Similarly, acceptable following distances or spacing may be received with respect to group-ride-aid spacing, tailgate distance, rear collision distance, and so on, any of which preferences can be used to adjust the sensitivity or timing of the indicating features of graphical proximity zones 118. Further, in addition to adjustability based on operator preference, in some embodiments, some or all graphical proximity zones 118 may be selectably turned on or off if warnings are not desired.

As described in detail above with respect to FIGS. 1-4, embodiments of the present disclosure include various systems and devices for determining motorcycle proximity regions and displaying graphical representations of those proximity regions. As also described above, embodiments also include various methods of determining motorcycle proximity regions, as well as presenting, conveying or graphically displaying motorcycle proximity regions to an operator of a motorcycle, methods of operating a motorcycle, and other methods as described above.

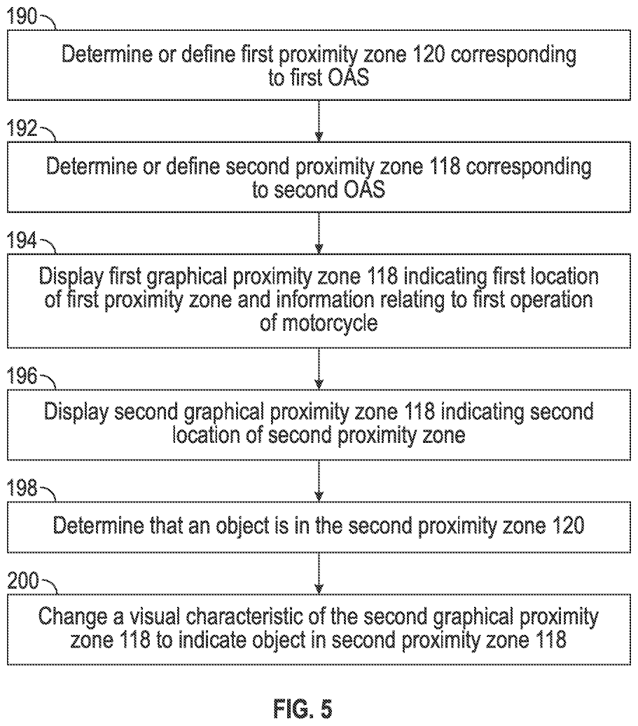

FIG. 5 is a flow chart describing one embodiment of a method for conveying proximity information to an operator of motorcycle 108 that includes vehicle user-interface device 100 and multiple operator-assistance systems.

Step 190 includes determining or defining a first proximity zone of the motorcycle, which in an embodiment is front-center proximity zone 120fc, though first proximity zone of this step may be any one or more of the other proximity zones 120 described herein. The first proximity zone includes and corresponds to a first spatial area in a vicinity of motorcycle 108 as described above, and also may correspond to a first operator-assistance system, such as ACC 174 or FCW 166, or one or more operator assistance systems, including those described herein.

Step 192 includes defining a second proximity zone of the motorcycle, which in an embodiment is rear-left proximity zone 120rl or rear-right proximity zone 120rr, though second proximity zone of this step may be any one or more of the other proximity zones 120 described herein. The second proximity zone includes and corresponds to a second spatial area in a vicinity of motorcycle 108 as described above, and also may correspond to a second operator-assistance system, such as BSD 160 for detecting an object in a blind spot.

Step 194 includes displaying a first graphical representation of the first proximity zone, such as graphical proximity zone 118fc on display screen 104, the first graphical representation indicating a first location of the first proximity zone relative to the motorcycle and indicating information relating to a first operation of the motorcycle. The operation of the motorcycle may include various controls and operations of motorcycle 108, including those relating to operator-assistance systems, and may include operations such as acceleration and deceleration, which may be part of an automatic cruise control operation of ACC 164, braking, speed, steering, lane changing, lane positioning, and so on.

Step 196 includes displaying a second graphical representation of the second proximity zone 118 on display screen 104 of motorcycle 108, the second graphical representation 118 indicating a second location of the second proximity zone 120 relative to motorcycle 108.

Step 198 includes determining that an object is in the second proximity zone 120.

Step 200 includes changing a visual characteristic of the graphical representation of the second proximity zone 118, thereby indicating that the object is within the second proximity zone 118.

Embodiments of the disclosure also include non-transitory computer-readable mediums onto which are stored instructions that are executable by processor(s) of system 152, and cause the processor to perform the methods described above.

Referring again to FIG. 1, proximity UI 106 as depicted provides a first configuration that an operator may select to display on display screen 104, which predominately depicts motorcycle proximity map 116 and its graphical proximity zones 118. However, in other embodiments, proximity UI 106 in an alternate or second configuration may be added to, or overlay, other information displayed, which may or may not be related be related to proximity zones 120. Such other information may include navigation information, maps, motorcycle system status information (e.g., engine temperature, fuel level, tire pressure), operational information (e.g., current speed, direction), environmental information (e.g., temperature, wind speed, precipitation), and other information.

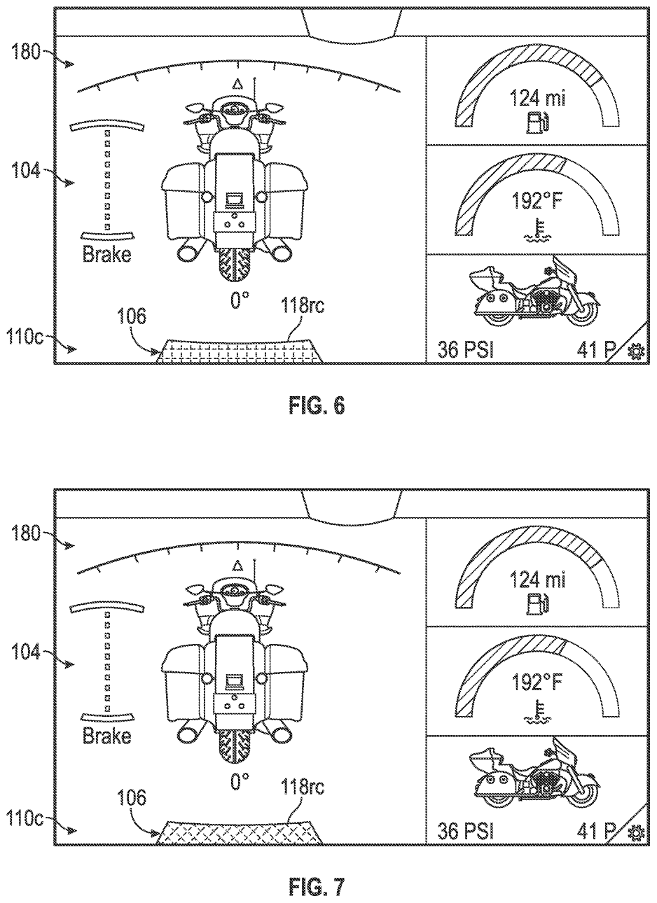

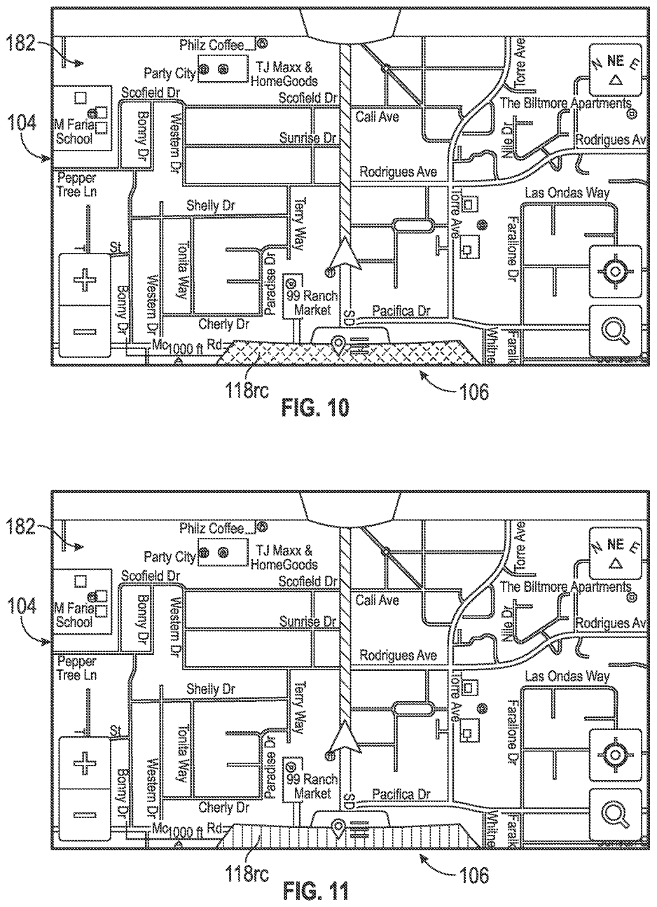

FIGS. 6-16 depict various embodiments of proximity UI 106 displayed in conjunction with other graphical user interfaces of motorcycle 108. In such embodiments, proximity UI 106 functions as an overlay, displaying proximity information and indicators “on top of” other informational displays or GUIs. In the depicted embodiments, proximity UI 106 primarily is displayed in perimeter areas of window 110, including at any of upper window area 110a, lower window area 110c, left window area 110d, and right window area 110e.

Referring specifically to FIGS. 6-8, an embodiment of proximity UI 106 displayed over a motorcycle system GUI, such as motorcycle status GUI 180 is depicted. In this embodiment, motorcycle status GUI includes multiple windows depicting a braking status, fuel gauge, engine temperature, and tire pressure. Proximity UI 106 in this embodiment comprises a graphical representation of rear-center proximity zone 120, graphical proximity zone 118rc. Graphical proximity zone 118rc is positioned at a bottom center of display screen 104 to indicate information relating to a rear center proximity zone behind the motorcycle.

Although FIGS. 6-8 depict proximity UI 106 presenting graphical proximity zone 118rc, it will be understood that other or additional graphical proximity zones 118 may be depicted. In an embodiment, the display of certain zones 118 may be user selectable, or may automatically be selected by sensing and control system 152. Sensing and control system 152 may select graphical proximity zones 118 for display based on various factors, such as a standard setting, detected hazards, predetermined priorities, underlying GUI type, and so on.

In an embodiment, proximity UI 106 may present graphical images, such as graphical proximity zones 118 as transparent images, such that the underlying GUI 180 may be viewed in its entirety. In other embodiments, proximity UI 106 may display opaque images when information presented by proximity UI 106 is intended to be emphasize over images of GUI 180.

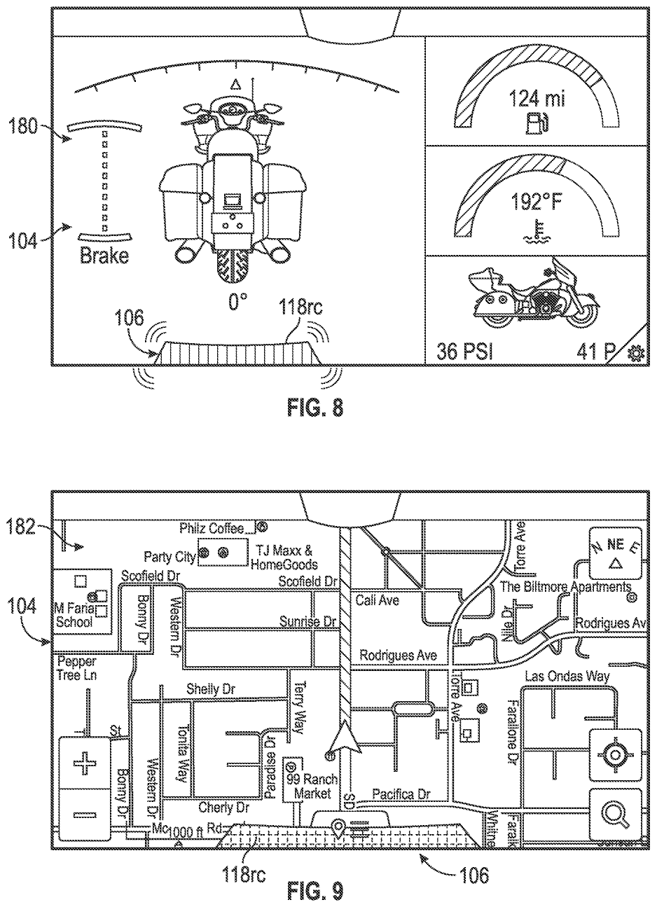

In FIG. 6, graphical proximity zone 118rc is displayed in a first color, which may be yellow, which in an embodiment may indicate a “normal” condition, or a condition in which no objects are in or approaching rear-center proximity zone 120. In FIG. 7, sensing and control system 152 has caused graphical proximity zone 118rc to be displayed in a second color, which in an embodiment, may be orange. The second color, orange, may indicate to an operator that a vehicle is approaching, such as would be detected by RCW system 168. In FIG. 8, graphical proximity zone 118rc is depicted in a third color, which may be red, indicating that a vehicle is very close to motorcycle 108, or that a collision is imminent. In an embodiment, graphical proximity zone 118rc may flash, or have a brightness level be selectively turned up and down, thereby providing a second visual indication of a rearward hazard.

Referring to FIGS. 9-11 an embodiment of proximity UI 106 of FIGS. 6-8 is displayed over a map or navigation GUI 182. Similar to FIGS. 6-8, proximity UI 106 is displayed over underlying GUI 182, which is a navigation GUI. In this similar embodiment, a color of graphical proximity zone 118rc is changed from yellow to orange to red, as is depicted from FIGS. 9 to 11.

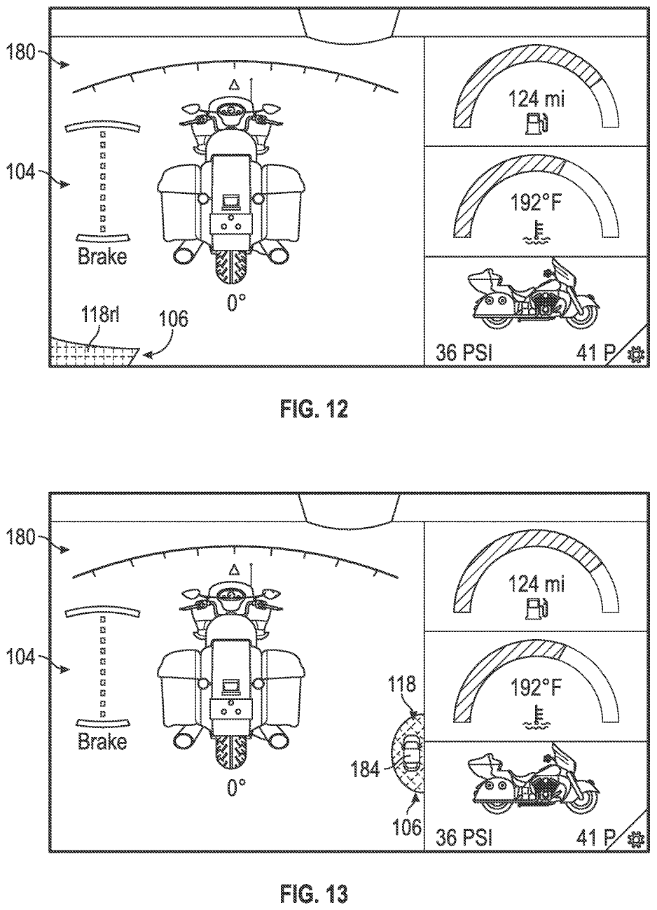

Referring to FIG. 12, in another embodiment, proximity UI 106 is displayed over underlying motorcycle status GUI 180, but in this instance, graphical proximity zone 118rl is displayed, which may correspond to a blind-spot zone or area. Similar to FIGS. 6-8, a color of graphical proximity zone 118rl may be changed to indicate information as a position of an object or vehicle in zone 118rl changes.

Referring to FIG. 13, in another embodiment, proximity UI 106 is displayed over underlying motorcycle status GUI 180, but in this instance, graphical proximity zone 118 is displayed, which may correspond to another blind-spot zone or area at a left side of motorcycle 108. Similar to FIGS. 6-8, a color of graphical proximity zone 118 may be changed to indicate information as a position of an object or vehicle in zone 118 changes. In the embodiment depicted, icon 184 of the vehicle in the blind spot is depicted in the graphical proximity zone 118. In an embodiment, graphical proximity zone 118 may be displayed based on data provided by BSD 160 or by lane keeping OAS 178.

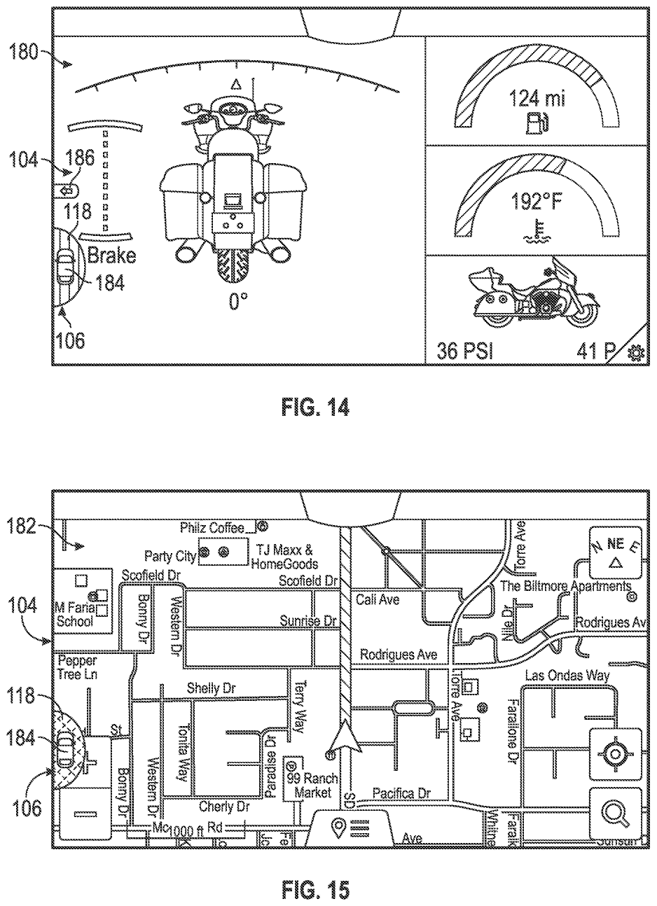

Referring to FIG. 14, in another embodiment similar to FIG. 13, proximity UI 106 is displayed over underlying motorcycle status GUI 180, but in this instance, graphical proximity zone 118 is displayed, which may correspond to another blind-spot zone or area at a left side of motorcycle 108. Similar to FIGS. 6-8, a color of graphical proximity zone 118 may be changed to indicate information as a position of an object or vehicle in zone 118 changes. In the embodiment depicted, icon 184 of the vehicle in the blind spot is depicted in the graphical proximity zone 118. In an embodiment, graphical proximity zone 118 may be displayed based on data provided by BSD 160 or by lane keeping OAS 178. In this embodiment, an additional graphical icon, arrow icon 186, may be displayed to indicate that a vehicle is in a proximity zone at a left-side of motorcycle 108.

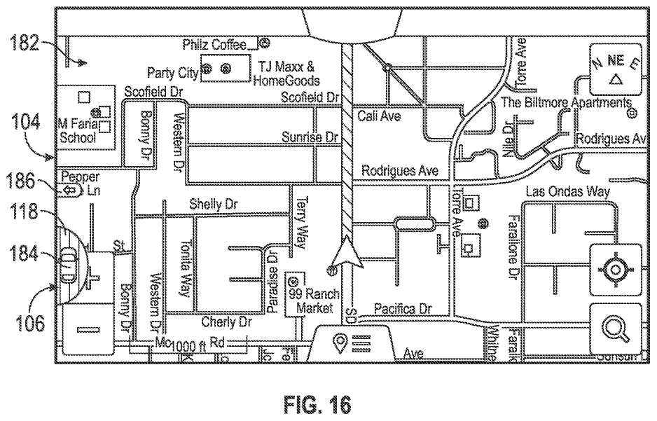

Referring to FIGS. 15-16, proximity UI 106 displays graphical proximity zone 118 with other-vehicle icon 184 at a left-side of display screen 104, indicating a vehicle to the left of motorcycle 108, overlaying navigation GUI 182. FIG. 16 also depicts arrow icon 186.

The invention is not restricted to the details of the foregoing embodiment(s). The invention extends to any novel one, or any novel combination, of the features disclosed in this specification (including any incorporated by reference references, any accompanying claims, abstract and drawings), or to any novel one, or any novel combination, of the steps of any method or process so disclosed. The above references in all sections of this application are herein incorporated by references in their entireties for all purposes.

While the aforementioned particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

All of the above patents and patent publications are incorporated herein by reference in their entirety for all purposes, except for express definitions and patent claims contained therein.

What is claimed is:

1. A method of conveying proximity information to an operator of a motorcycle, comprising:
determining a plurality of proximity zones of the motorcycle, each of the plurality of proximity zones corresponding to a spatial area in a vicinity of the motorcycle;
displaying a graphical representation of each of the plurality of proximity zones on a display screen of the motorcycle, the graphical representation indicating a location of each of the plurality of proximity zones relative to the motorcycle;
determining that an object is within one of the plurality of proximity zones of the motorcycle; and
changing a visual characteristic of the graphical representation of the proximity zone having the object, thereby indicating that the object is in the proximity zone.

2. The method of claim 1, wherein determining the plurality of proximity zones includes receiving sensor data of one or more sensors of the motorcycle at a processor, and defining the plurality of proximity zones based on the sensor data of the one or more sensors.

3. The method of claim 1, wherein determining the plurality of proximity zones includes determining a first proximity zone corresponding to a first operator-assistance system, and determining a second proximity zone corresponding to a second operator-assistance system.

4. The method of claim 3, wherein the first operator-assistance system is an adaptive cruise control system, and the second operator-assistance system is a forward collision warning system.

5. The method of claim 1, wherein one of the plurality of proximity zones is forward of the motorcycle and one of the plurality of proximity zones is rearward of the motorcycle.

6. The method of claim 5, wherein displaying a graphical representation of each of the plurality of proximity zones on a display screen of the motorcycle includes displaying a graphical representation of the proximity zone that is forward of the motorcycle at a top portion of display screen, and displaying a graphical representation of the proximity zone that is rearward of the motorcycle at a bottom portion of the display screen.

7. The method of claim 1, wherein changing a visual characteristic of the graphical representation of the proximity zone having the object includes changing a color of the graphical representation of the proximity zone having the object.

8. The method of claim 1, wherein changing a visual characteristic of the graphical representation of the proximity zone having the object includes adding a graphical icon over the displayed proximity zone having the object.

9. The method of claim 1, further comprising detecting and displaying information relating to traffic control.

10. A method of conveying proximity information to an operator of a motorcycle, comprising:
defining a first proximity zone of the motorcycle, the first proximity zone including a first spatial area in a vicinity of the motorcycle and corresponding to a first operator-assistance system;
defining a second proximity zone of the motorcycle, the second proximity zone including a second spatial area in a vicinity of the motorcycle and corresponding to a second operator-assistance system;
displaying a first graphical representation of the first proximity zone on a display screen of the motorcycle, the first graphical representation indicating a first location of the first proximity zone relative to the motorcycle and indicating information relating to a first operation of the motorcycle;
displaying a second graphical representation of the second proximity zone on the display screen of the motorcycle, the second graphical representation indicating a second location of the second proximity zone relative to the motorcycle;
determining that an object is in the second proximity zone; and
changing a visual characteristic of the second graphical representation of the second proximity zone, thereby indicating that the object is within the second proximity zone.

11. The method of claim 1, wherein the first operator-assistance system is selected from the group consisting of a blind-spot detection (BSD) system, automatic or emergency brake assist system (ABS), adaptive cruise control (ACC), forward collision warning (FCW) system, road-sign detection system, wildlife detection system, group-ride-aid system, lane keeping or changing assistance system and wherein the second operator-assistance system is selected from the group consisting of a blind-spot detection (BSD) system, automatic or emergency brake assist system (ABS), adaptive cruise control (ACC), forward collision warning (FCW) system, road-sign detection system, wildlife detection system, group-ride-aid system, lane keeping or changing assistance system, the first operator-assistance system being different from the second operator-assistance system.

12. The method of claim 11, wherein the first operator-assistance system is an adaptive cruise control system, and the second operator-assistance system is a forward collision warning system.

13. The method of claim 10, wherein determining the first and second proximity zones includes receiving sensor data of one or more sensors of the motorcycle at a processor, and defining the first and second proximity zones based on the sensor data of the one or more sensors.

14. The method of claim 10, wherein the first proximity zone is forward of the motorcycle and the second proximity zone is rearward of the motorcycle.

15. The method of claim 14, wherein displaying a first graphical representation of the first proximity zone on a display screen of the motorcycle includes displaying a first graphical representation of the proximity zone that is forward of the motorcycle at a top portion of display screen, and displaying a second graphical representation of the second proximity zone on a display screen of the motorcycle includes displaying a second graphical representation of the proximity zone that is rearward of the motorcycle at a bottom portion of the display screen.

16. The method of claim 10, wherein changing a visual characteristic of the second graphical representation of the second proximity zone having the object includes changing a color of the second graphical representation of the proximity zone having the object.

17. The method of claim 10, wherein changing a visual characteristic of the second graphical representation of the second proximity zone having the object includes adding a graphical icon over the displayed second graphical representation of the second proximity zone having the object.

18. The method of claim 10, further comprising detecting and displaying information relating to traffic control.

19. The method of claim 10, wherein the information relating to the first operation of the motorcycle includes one or more of a motorcycle speed, fuel level, engine temperature, tire pressure, suspension setting, outside air temperature, and audio system setting.

20. A method of conveying proximity information to an operator of a motorcycle, comprising:
displaying a graphical representation of a status of the motorcycle on a display screen;
determining a proximity zone of the motorcycle, the proximity zone including a spatial area in a vicinity of the motorcycle;
displaying a graphical representation of the proximity zone on the display screen of the motorcycle, the graphical representation indicating a location of the proximity zone relative to the motorcycle, and displayed in a same display window as the graphical representation of the status of the motorcycle on the display screen as an overlay;
determining that an object is in the proximity zone of the motorcycle; and
changing a visual characteristic of the graphical representation of the proximity zone, thereby indicating that the object is in the proximity zone.

21. The method of claim 20, wherein the status of the motorcycle includes one or more of a motorcycle speed, fuel level, engine temperature, tire pressure, suspension setting, outside air temperature, and audio system setting.

22. The method of claim 20, wherein displaying a graphical representation of the proximity zone on the display screen of the motorcycle includes displaying only one graphical representation of the proximity zone on the display screen of the motorcycle.

23. The method of claim 22, wherein the displayed graphical representation is transparent.

24. A system for determining and conveying proximity information to an operator of a motorcycle, comprising:
a sensor coupled to the motorcycle and configured to sense an object in a vicinity of the motorcycle;
a display device including a display screen; and
a processor in communication with the sensor and the display device, the processor configured to:
receive data from the sensor,
determine a first proximity zone of the motorcycle, the first proximity zone including a first spatial area in a vicinity of the motorcycle and corresponding to a first operator-assistance system;
determine a second proximity zone of the motorcycle, the second proximity zone including a second spatial area in the vicinity of the motorcycle and corresponding to a second operator-assistance system;
cause a first graphical representation of the first proximity zone on to be displayed on the display screen of the display device, the first graphical representation indicating a first location of the first proximity zone relative to the motorcycle and indicating information relating to a first operation of the motorcycle;
cause a second graphical representation of the second proximity zone to be displayed on the display screen of the motorcycle, the second graphical representation indicating a second location of the second proximity zone relative to the motorcycle;
determine, based on the received data from the sensor, that an object is in the first or the second proximity zone;
cause a visual characteristic of the graphical representation of the first or the second proximity zone to change, thereby indicating that the object is within the first or the second proximity zone.

25. The system of claim 24, wherein the sensor is a camera, a RADAR sensor, a LIDAR sensor, a wheel-speed sensor, a brake sensor or a gyroscope.

26. The system of claim 24, wherein the display screen is a touch screen.

27. A motorcycle proximity user-interface device for conveying proximity information to an operator of a motorcycle, comprising:
a display device including a display screen, the display device configured to receive input from the operator of the motorcycle and to display a proximity graphical user interface displaying the proximity information;
a processor configured to:
receive data from a sensor of the motorcycle,
determine a proximity zone of the motorcycle, the proximity zone including a first spatial area in a vicinity of the motorcycle and corresponding to an operator-assistance system;
cause the proximity graphical user interface to be displayed on the display screen of the display device, the proximity graphical user interface indicating a first location of the fist proximity zone relative to the motorcycle and indicating information relating to operation of the motorcycle; and
cause a visual characteristic of the proximity graphical user interface, thereby indicating that an object is within the proximity zone.
